(19) United States
(12) Patent Application Publication
(10) Pub. No.: US 2006/0112277 A1
(43) Pub. Date: May 25, 2006

(54) High-speed password attacking device

(76) Inventors: Steven Bress, Germantown, MD (US); Mark Joseph Menz, Folsom, CA (US); Daniel Bress, Germantown, MD (US)

Correspondence Address: Steven Bress, 7851-C Beechcraft Avenue, Gaithersburg, MD, 20879, US

(21) Appl. No.: 10/995,619

(22) Filed: Nov. 23, 2004

(51) Int. Cl. H04K 1/00

(52) U.S. Cl. 713/184

(57) ABSTRACT

An improved high-speed password attacking device for finding the password of a long-term storage device includes a power supply, a control circuit, and an interface to the storage device. The control circuit submits potential passwords to the long-term storage device, resetting it as necessary. The storage device may be, for example, a hard disk drive or compact flash memory. The application specific device is physically small, is operating system independent, and has simple interface that is useable by non-computer professionals.

### BACKGROUND OF THE INVENTION

A. Field of the Invention

The present invention relates to computer memory devices and, more specifically, to mechanisms for identifying passwords protecting those memory devices.

B. Description of Related Art

For the sake of clarity the following discussion will concern IDE computer long-term memory devices, such as hard drives and flash memory. One skilled in the art will appreciate that the method and systems disclosed here are applicable to other types of drives and our current invention is not limited to IDE devices.

There are two components to modern long-term storage devices; 1. a physical media which holds data and 2. a drive controller which reads and writes data on the physical media, when given instructions from a host. The drive controller may require a password before reading or writing data. As an additional security measure, the drive controller may lock-up after a certain number of incorrect password attempts, typically 5 tries. Once a drive controller is locked up, it will not accept any commands from a host until it is reset.

If the proper password is known, there is no problem, and no need for our current invention. However, criminals of all sorts have a desire to password protect their data while police and security officers have an obvious need to defeat this password protection. Our current invention submits potential passwords to a drive controller until one is accepted or a user intervenes. After typically five unsuccessful attempts the drive controller locks up. Our current invention unlocks (resets) the drive controller in as little as 50 Milliseconds, and continues to submit potential passwords. This process is called password “attacking” and/or “cracking” a drive.

A conventional software method of attacking computer long-term memory devices is by connecting a long-term memory device to a working standard computer (PC) operating system and running specialized software to attack the device. There are a number of potential problems with this approach. First, an expensive PC must be taken from productive service, along with the desk space needed to support its keyboard, monitor and mouse. Second, a trained user must attach the target drive to the host machine. During this process, the host machine must be shut down, the target drive properly installed, and configured with a valid address or master/slave status, and finally the host machine rebooted. This can be a time consuming process requiring a trained user. Finally, there is a potential system problem. Most PCs are not designed for hard drives being swapped in an out on a regular basis. A static charge or cable failure while installing a target drive can damage not only the target drive but also the host machine.

The above-mentioned system has the potential for changing long-term memory. The simple act of connecting a hard drive to a computer may cause the computer to write information to the drive, thus altering it. In computer forensic, legal and security applications, a hard drive may not be altered at all.

Perhaps the biggest problem with using a PC to attack a drive is the amount of time it takes. After a drive controller locks up due to unsuccessful password attempts the PC must be rebooted, a process that can take minutes. As the process of attacking a drive may take thousands or even millions of attempts, rebooting a PC after every five attempts is extremely time intensive.

Accordingly, there is a need in the art to more efficiently password attack long-term memory devices such as hard drives.

### SUMMARY OF THE INVENTION

Systems and methods consistent with the principles of this invention provide for an easy to use and portable high-speed password attack device.

One aspect of the invention is directed to a device for conducting high-speed password attacks on a long-term memory component. The device includes an interface for connecting the device to the long-term memory component and a control circuit configured to present potential passwords to the long-term memory component through the interface and to reset the long-term memory component controller as necessary. A user controllable switch, when actuated by a user, causes the control circuit to commence an attack on the long-term memory component. The device includes a communication interface configured to display the results of this attack to a user.

A method consistent with aspects of the invention includes connecting a power supply to a password attack device, connecting a cable associated with the attacking device to a long-term memory component in a computer, and powering-up the computer. The method further includes activating the attacking device via a switch attached to the attacking device, presenting potential passwords to the long-term memory component and resetting the device controller as necessary, signaling completion of password attack, and communicating this information.

Another method consistent with aspects of the invention includes connecting a power supply to a password attacking device, connecting a cable associated with the password attacking device to a long-term memory component, and connecting a power cable attached to the password attacking device to the long-term memory component. The method further includes activating the attacking device via a switch attached to the attacking device, presenting potential password to the long-term memory component and resetting its controller as necessary, signaling completion of the password attack, and communicating this information.

Yet another aspect of the invention is directed to a device for presenting potential passwords a long-term memory component, and resetting its controller as necessary. The device includes LEDs configured to provide feedback relating to an operational status of the device to a user, a user settable switch, a communication interface to display the retrieved identification information to a user, and a long-term memory interface for connecting to a long-term memory component. The device further includes circuitry coupled to the LEDs, the user settable switch, the communication interface, and the long-term memory interface, the circuitry configured, when the switch is actuated by the user, to present potential passwords to a long-term memory component through the interface and reset the long-term memory components controller as necessary, and to communicate the results of this operation to a user through the communication interface. The circuitry is enclosed in a portable casing and the LEDs, the user controllable switch, the communication interface and the long-term memory interface are mounted on an external portion of the casing.

### BRIEF DESCRIPTION OF THE DRAWINGS

The accompanying drawings, which are incorporated in and constitute a part of this specification, illustrate the invention and, together with the description, explain the invention. In the drawings,

FIG. 1 is a block illustration illustrating a password attacking device consistent with an aspect of the present invention;

FIG. 2 is a diagram illustrating portions of the password attacking device shown in FIG. 1 in additional detail;

FIG. 3 is a diagram illustrating portions of the password attacking device shown in FIGS. 1 and 2 in additional detail;

FIG. 4 is a diagram of an external view of an implementation of the password attacking device;

FIG. 5 is a flow chart illustrating operation of the password attacking device of FIG. 4 when querying a drive located within a host computer;

FIG. 6 is a diagram of external view of another implementation of the password attacking device;

FIG. 7 is a flow chart illustrating operation of the password attacking device of FIG. 6 when attacking a detached drive; and

FIG. 8 is a flow chart illustrating operation of the attacking device consistent with an aspect of the invention.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

A password attacking device for presenting potential passwords to long-term memory devices, such as hard drives, and resetting their controllers as necessary, includes a host circuit that performs operations on a target drive to return information to the host circuit. The password attacking device is physically compact, is relatively simple to operate, and is operating system independent.

Storage devices discussed herein may be any type of long-term non-volatile memory device. For example, the storage device may be a hard disk drive or compact flash memory. In one implementation, the storage device uses an Integrated Drive Electronics (IDE) interface. An IDE interface is a well-known electronic interface that is frequently used to connect a computer's motherboard and disk drive.

Although concepts consistent with the present invention are primarily described herein in relation to an IDE magnetic hard disk drive, these concepts may be implemented with other types of IDE media, such as flash memory with an IDE interface. Flash memories are a special type of semiconductor random access memory that retains its data after power has been removed from the system. Other types of media useable with an IDE interface include magnetic tape. In addition to the IDE interface, concepts consistent with the invention may be applied in a straightforward manner to other types of high level storage interfaces, such as the well known Small Computer System Interface (SCSI) standard or a hard drive connected through an IEEE 1394 (Firewire) connection.

For the sake of clarity the remaining description herein will be described with reference to an IDE magnetic hard disk drive, although, as mentioned above, the concepts of the invention are not limited to such drives. One skilled in the art would appreciate that other modern long-term storage device interfaces share similar functionality that could be incorporated into the concepts described herein.

### Password Attack Device

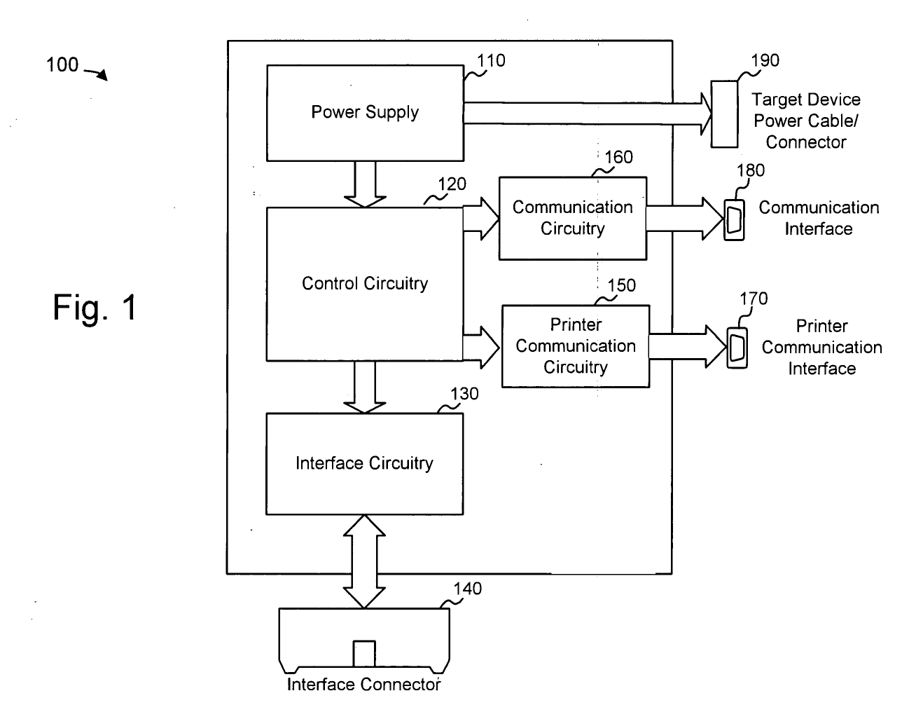

FIG. 1 is a block diagram illustrating a password attacking device 100 consistent with an aspect of the present invention. Query device 100 includes power supply 110, control circuitry 120, interface circuitry 130, an interface connector 140, printer communication circuitry 150, and communication circuitry 160. Power supply 110 supplies power through a power cable connector 190, printer communication circuitry 150 may connect to a printer communication interface 170, and communication circuitry 160 may connect to a communication interface 180.

A hard disk drive or compact flash drive (target drive) attaches to interface connector 140. As will be described in more detail below, control circuitry 120 submits instructions (potential passwords) to the target drive and resets it as necessary. In other words, the target drive is “attacked” by password attacking device 100. Interface circuitry 130 passes instructions through connector 140 to the target device. Power supply 110 provides power to both control circuitry 120 and interface circuitry 130.

Printer communication circuitry 150 allows password attacking device 100 to communicate with a host computer, such as a personal computer. Communication interface 170 may be a serial interface that may be connected to a personal computer. Printer communication circuitry 150 may then handle the serial communication protocols between the personal computer and attacking device 100. Additionally instead of connecting to a personal computer, printer communication interface 170 may be used to interface directly to a stand-alone printer, through which information may be output. Printer communication interface 170 is optional. In one implementation, query device is implemented as a stand-alone device with an LCD panel, or built-in printer used to communicate to a user rather than using a separate computer or printer.

Communication circuitry 160 allows password attacking device 100 to communicate with a host computer, such as a personal computer. Communication interface 180 may be a serial interface that may be connected to a personal computer. Communication circuitry 160 may then handle the serial communication protocols between the personal computer and attacking device 100. A personal computer may be used in this iteration to pass potential passwords to the attacking device. Additionally, instead of connecting to a personal computer, communication interface 180 may be used to interface directly to a stand-alone printer, through which status information may be output. Communication circuitry 160 and communication interface 180 are optional. In one implementation, attacking device is implemented as a stand-alone device that may be used to query hard drives without using a separate computer. In another iteration, interface 160 may be used to start and/or stop password attack procedures.

Password attacking device 100 may be designed as a relatively small, lightweight, and easily portable device. In one implementation, attacking device 300 is embodied in a case approximately 5″×7″×1.3″.

Power cables allow power to be supplied to the target disk drive through power connector 190. This allows attacking device 100 to process a target drive whether or not the target drive is still connected to a working computer or similar device (host).

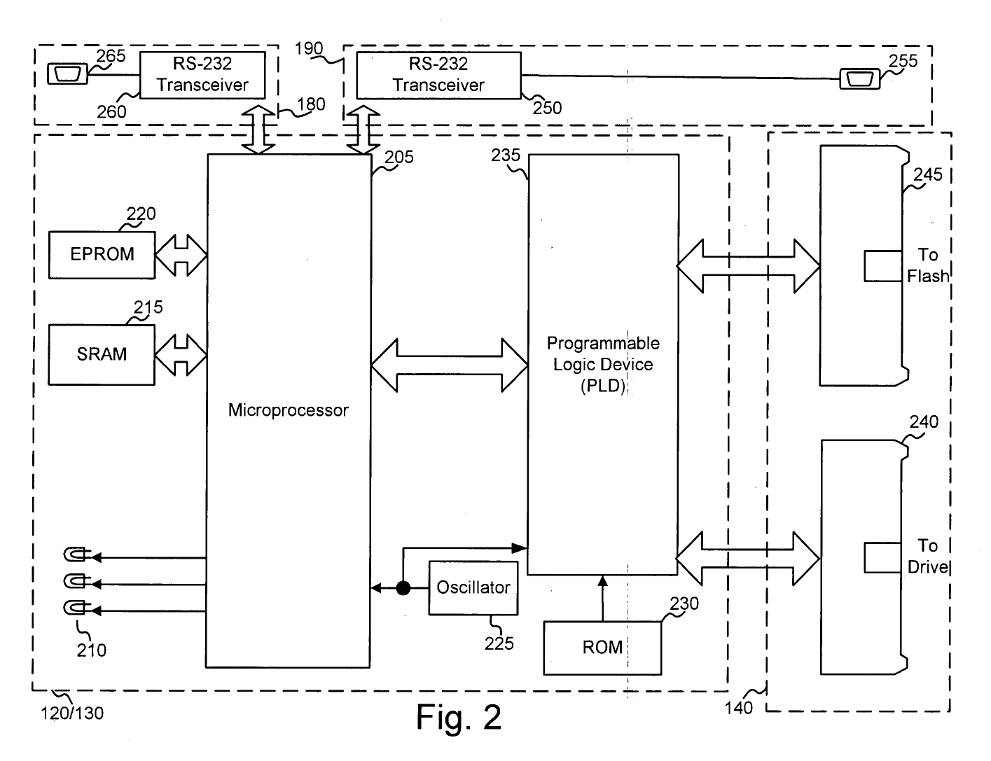

FIG. 2 is a diagram illustrating portions of password attacking device 100 in additional detail. Control circuitry 120 and interface circuitry 130 of attacking device 100 includes microprocessor 205 and programmable logic device (PLD) 235. Microprocessor 205 may be an embedded processor, such as the 80386 EX embedded processor manufactured by Intel Corporation, of Santa Clara, Calif. The integrated design of microprocessor 205 allows relatively little additional circuitry to be used to create a small, dedicated computer system. PLD 235 complements microprocessor 205 by performing logical operations required by the microprocessor 205 or other circuitry of attacking device 100. ROM 230 stores configuration data that is initially loaded into PLD 235 on start-up. Similarly, EPROM 220 stores the initial code necessary to initialize and run microprocessor 205. Static RAM (SRAM) 215 is also connected to microprocessor 205, and is used for temporary program and data storage. Crystal oscillator 225 provides clocking signals to microprocessor 205 and PLD 235. In one implementation, crystal oscillator 225 generates a 50 MHz clock signal.

Microprocessor 205 may control external devices, such as LED status indicators 210. Through LED status indicators 210, microprocessor 205 may provide easily understandable feedback to a user. For example, one of LEDs 210 may be a green LED that is powered by microprocessor 205 when it finishes attacking a drive. Alternatively, microprocessor 205 may cause an audible sound to be produced when it finishes attacking a drive.

Interface 140 may include a hard drive interface 240. Drive interface 240 may be a standard IDE drive interface that connects attacking device 100 to the target drive. Interface 140 may also include a compact flash interface 245 which, in a similar manner, allows attacking device 100 to connect to and interrogate compact flash memory devices.

In addition to connecting to the target drive through interface circuitry 140, microprocessor 205 may be connected to external devices via RS-232 port 255 and RS-232 transceiver 250. RS-232 port 255 may be a standard DB9 connector that allows connections using a standard DB9 male to female serial cable.

In addition to connecting to the target drive through interface circuitry 140, microprocessor 205 may be connected to external devices, such as printers or other display devices, via RS-232 port 265 and RS-232 transceiver 260. RS-232 port 265 may be a standard DB9 connector that allows connections using a standard DB9 male to female serial cable.

One of ordinary skill in the art will recognize that the components shown in FIG. 2 may be selected from a wide variety of commercially available components. In one implementation, the components in FIG. 2 may be selected as follows: PLD 235, part number EP1K50QC208-2, available from Altera Corporation of San Jose, Calif.; ROM 230, part number EPC1PC8, available from Altera Corporation; EPROM 220, part number AT27LV020A90JC, available from Atmel Corporation, of San Jose, Calif.; and SRAM 215, part number CY7C1021V33L12ZCT, available from Cypress Corporation, of San Jose, Calif.

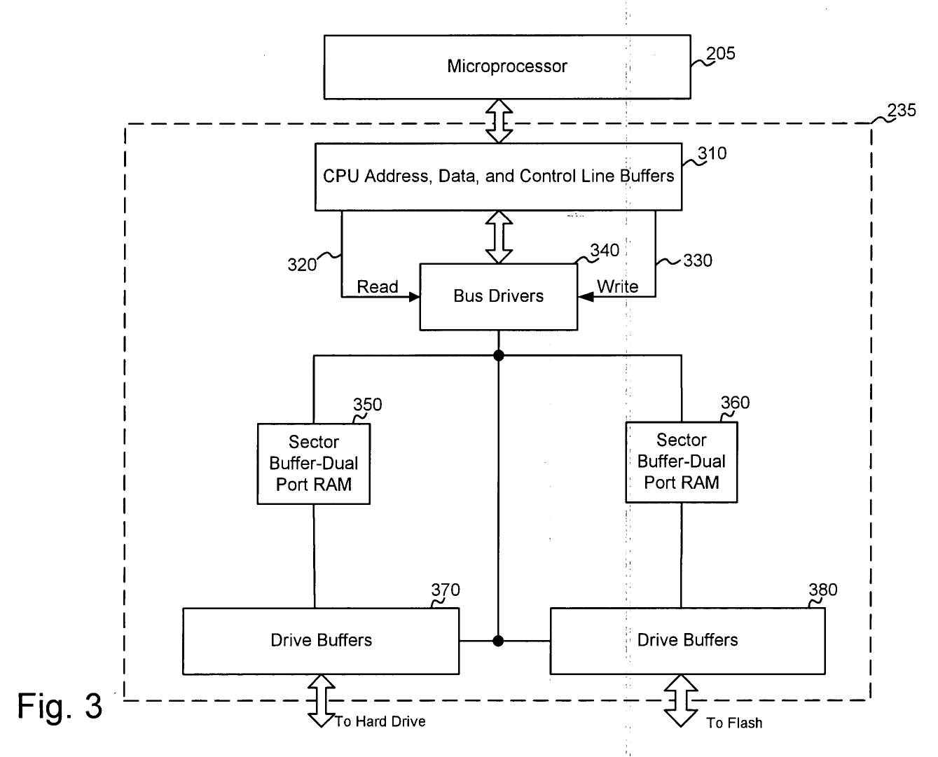

FIG. 3 is diagram that graphically illustrates the functionality of PLD 235 in additional detail. Address, data, and control lines from the microprocessor 205 are routed to PLD 235 where their information is buffered and latched as necessary in buffers 310. Buffers 310 serve to reduce the electrical load on the processor and to stabilize the signal timing. Buffer read and write signals 320 and 330 control the direction of the bus drivers 340. Thus, bus drivers 340 may write data into buffers 310 when read signal 320 is active and read data out of buffers 310 when write signal 330 is active. Buffers 310 and bus drivers 340 help control the data flow and distribution of the address and data buses from the microprocessor 205 to other portions of PLD 235.

Buffering and signal conditioning for the target disk drive is provided by drive buffers 370, which form the drive interface with the target disk drive. Buffering and signal conditioning for compact flash is provided by drive buffers 380, which form the interface with the compact flash. Through the bus drivers 340, the microprocessor 205 can directly read and write to the drive interface associated with the target disk drive and compact flash.

Instead of directly communicating with drive buffers 370 and 380, bus drivers 340 may indirectly communicate with drive buffers 370 and 380 through dual ported RAM sector buffers 350 and 360. Sector buffer 350 provides an additional layer of buffering between the microprocessor 205 and the disk drive and/or compact flash. This allows the target drive to write one sector's worth of data to RAM at high speed, while the microprocessor 205 reads a previous sector's worth of data. By allowing the operations to overlap in this fashion, the microprocessor 205 is not restricted to running at the speed of the target drive or compact flash, and is free to handle other functions until it needs the data in the sector buffers 350 or 360.

Referring back to FIG. 2, microprocessor 205 may include a UART that may be used for serial communications. Microprocessor 205 connects to RS-232 transceivers 250 and 260, which buffers the signals and generates the necessary voltages required for RS-232 communications. DB9 connector 255 connects to a corresponding DB9 connector on a host device such as a personal computer. DB9 connector 265 connects to a corresponding RS-232 connector on a device such as a printer. Although communication circuitry 150 and 160 are shown as implementing a serial connection, in other implementations, other types of connections, such as parallel or USB connections, may be used.

### Operation of the Password Attacking Device

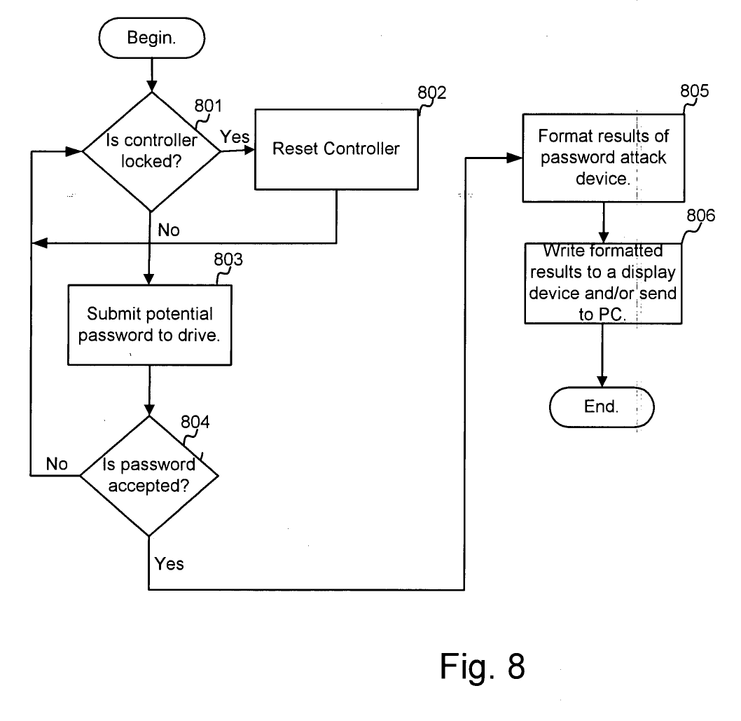

Password attacking device 100 operates on a target drive inserted into interface connector 140 to submit potential passwords and reset the controller as necessary. FIG. 8 is a flow chart illustrating operation of the attacking device (100) consistent with an aspect of the invention in additional detail. Attacking device 100 begins, through microprocessor 205 and PLD 235 by issuing an identify device command to the hard drive (Act 801). Attacking device reads the results of the IDENTIFY_DEVICE command (Act 801). These results are in the form of encoded bits. An IDE identify device packet is 256 words of data. Bit 4 of word 128 is the “expired” bit. This bit determines whether the drive has reached its limit of password attempts or is capable of receiving another password command. If the drive has reached its limit, Attacking device resets the drive's controller so that additional passwords may be sent to the drive.

Once the results of the IDENTIFY_DEVICE command indicates the drive is capable of receiving another password, Attacking device submits a potential password to the drive 803. If the password is correct 804, the newly discovered password is formatted for display to the user 805. The formatted results are displayed, printed, or sent to a PC 806, depending on the device configuration. If the password is incorrect, control passes back to 801 in order to determine whether the drive is ready for another password attempt or needs to be reset.

### External Structure and Operation of the Password Attacking Device

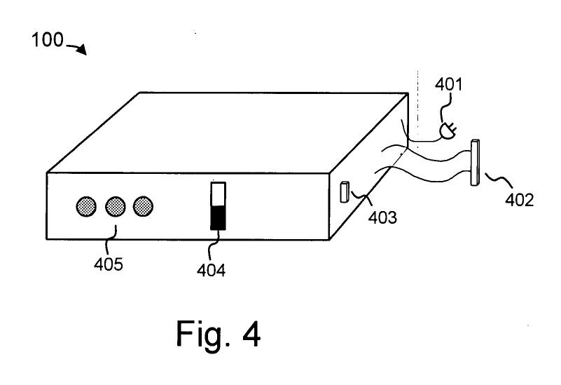

As previously mentioned, password attacking device 100 may be constructed in a relatively small case, such as a case as small or smaller than 5″×7″×1.3″. FIG. 4 is a diagram illustrating an external view of one implementation of query device 100 consistent with an aspect of the invention.

As shown in FIG. 4, the external portion of attacking device 100 may include a power cord with a wall socket plug 401, an IDE drive cable 402 that is long enough to lead from query device 100 to a hard drive in computer, a standard serial DB9 connector 403, an on/off switch 404, and LED status lights 405. Alternatively, query device 100 may include a battery compartment in place of or in combination with wall socket plug 401.

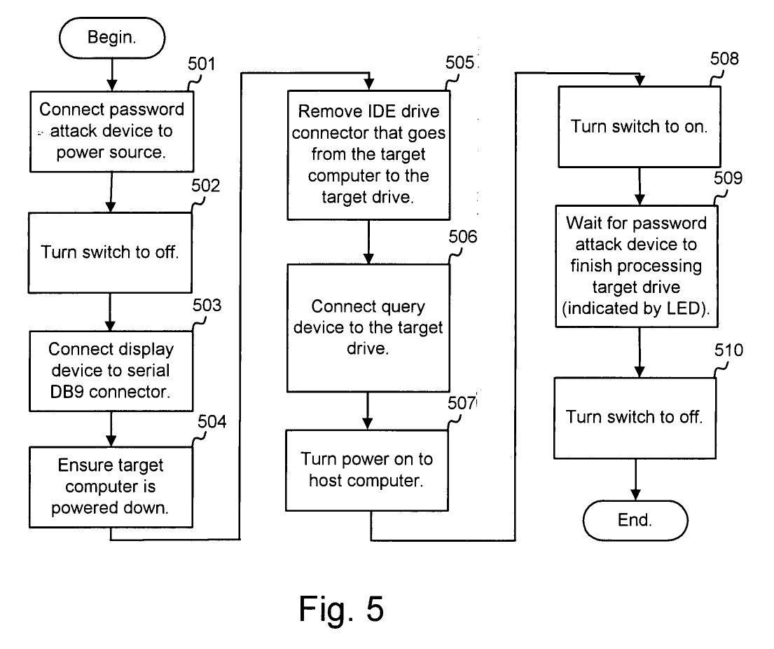

FIG. 5 is a flow chart illustrating operation of attacking device 100, as shown in FIG. 4, from the prospective of a user when attacking a hard disk drive located within a host computer.

A user begins by connecting attacking device 100 to a power supply (Act 501) and ensuring that switch 404 is set to the “off” state (Act 502). In one implementation, this may involve plugging socket plug 401 into a wall power outlet. The user plugs a display device, such as a printer, into the standard serial DP9 connector (Act 503). The user also ensures that the computer system with the target disk drive is powered down (Act 504). The user may then remove any IDE cables that are in the target drive (Act 505). This may involve removing the cover of the host computer and removing the IDE drive connector that connects the host computer and the drive. The user may then connect IDE drive cable 402 to the drive, turn power on to the host computer, and turn switch 404 to the “on” position (Acts 506, 507, and 508). In response, attacking device 100 will power on and attack the target drive to determine its password. The attack may proceed as previously discussed with reference to FIG. 8. When attacking device 100 has finished attacking the drive, it signals querying completion via LED status lights 405 (Act 509). For example, one of LED status lights 405 may flash on and off while attacking device 100 is operating. When attacking device 100 completes operating, the LED status light may remain steadily on. The user may then turn switch 404 to the “off” position and disconnect the attacking device from the host computer (Act 510).

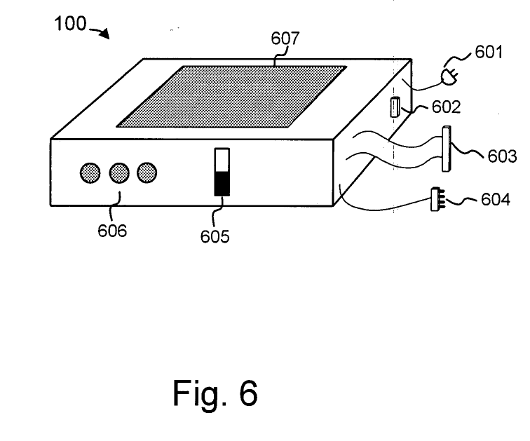

FIG. 6 is a diagram illustrating an external view of another implementation of attacking device 100 consistent with an aspect of the invention.

As shown in FIG. 6, the external portion of attacking device 100 may include a power cord with a wall socket plug 601, an IDE drive cable 603, an on/off switch 605, LED status lights 606, a drive power cord 604, a standard serial DB9 connector 602, and an anti-static cushion 607. A target drive may be placed on the anti-static cushion 607 and connected to the drive power cord 604 and the drive cable 604.

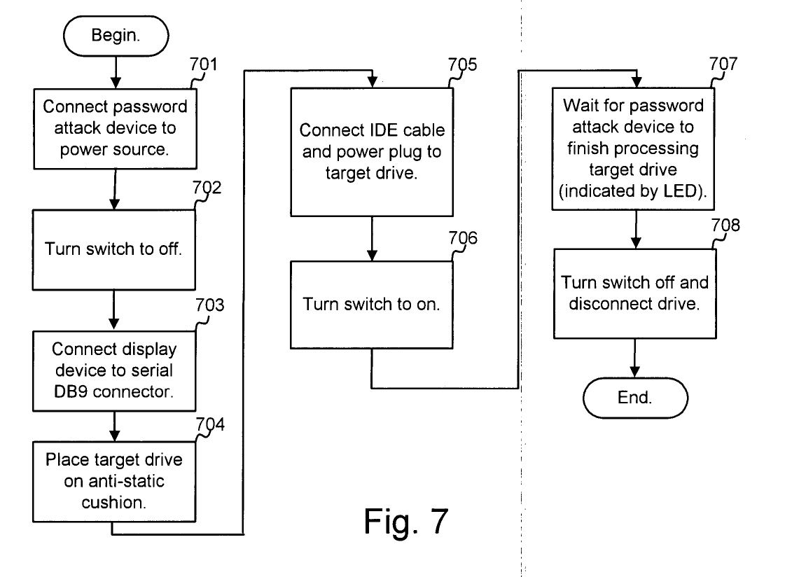

FIG. 7 is a flow chart illustrating operation of the attacking device 100, shown in FIG. 6, from the prospective of a user when attacking a detached hard disk drive.

A user begins by plugging socket plug 601 into a power supply (Act 701) and ensuring that switch 605 is set to the “off” state (Act 702). The user plugs a display device, such as a printer, into the standard serial DB9 connector (Act 703). The target drive is then placed on the anti-static cushion 607, the IDE drive cable 603 plugged into the target drive, and the drive power cord 604 plugged into the target drive (Acts 704 and 705). The user may then turn switch 605 to the “on” position (Act 706). In response, password attacking device 100 will power on and attack the drive in a manner similar to that described above with respect to FIG. 8. When attacking device 100 has finished attacking the drive, it signals completion via LED status lights 606 (Act 707). The user may then turn switch 605 to the “off” position and disconnect the attacking device and the target drive (Act 708).

As can be appreciated, the operation of password attacking device 100, from the prospective of the user, is relatively simple. Accordingly, attacking device 100 can be operated by only moderately trained technicians. Additionally, the operation simplicity of attacking device 100 makes it unlikely that a user will improperly use the attacking device in a manner that damages a disk drive.

### User Communication of Attacking Device Status

In the implementations described above, password attacking device 100 signals its operational status to a user through LEDs 405 or 606. For example, LEDs may be used to signal that: (1) attacking device 100 is performing operations on a target device, (2) attacking device 100 has finished attacking the target device, and (3) an error was encountered.

In alternate embodiments, attacking device 100 may include additional display devices such as a LCD graphical display, to communicate device status. With these output devices, additional status information such as number of password attempts, and information about the target device may be displayed.

### Additional Features

In the implementations described above, password device 100 has its method of selecting potential passwords set in hardware. In an alternative embodiment, attacking device 100 may include an interface that a user can set to vary the method potential passwords are selected, such as random, dictionary look-up, or special algorithm.

In yet another implementation, attacking device 100 could have a network interface to communicate with a display device. This network interface could in addition be used to allow a network pc to set what information method potential passwords are selected, as discussed in the above paragraph.

In yet another implementation, attacking device 100 could have a long-term memory storage device, such as a hard drive, to store dictionaries and other such lists to add in choosing potential passwords. In a similar fashion, attacking device 100 could have a removable memory, such as a flash drive, to enable a user additional input into choosing potential passwords.

In another implementation, attacking device 100 could include non-volatile and/or non-volatile removable memory. This memory could be used to store for storing the results of a password attack.

Although the attacking device discussed above was primarily described as attacking an IDE device, in other implementations, long-term storage devices having other interfaces, such as FireWire, USB, USB2, or SCSI could be attacked using concepts similar to those discussed herein.

### CONCLUSION

As described above, a password attacking device submits potential passwords to a target long-term memory device, and resets it as necessary. The attacking device is portable, provides easy to understand user feedback, has a simple user interface and could thus be effectively used by non-technical people.

The password attacking device has a number of advantages. It is operating system independent. The attacking device can operate while the target device is still physically located in the host computer system or when it has been removed from the host computer system. It is a stand alone device that can replace more complicated and more expensive devices or systems. Additionally, the attacking device does not require that the operator have any particular knowledge of the target device.

Additionally, the password attacking device can use different methods of selecting potential passwords. The attacking device provides feedback to a user that it has either performed operations correctly or has run into an error.

It will be apparent to one of ordinary skill in the art that the embodiments as described above may be implemented in many different forms of software, firmware, and hardware in the implementations illustrated in the figures. The actual software code or specialized control hardware used to implement aspects consistent with the present invention is not limiting of the present invention. Thus, the operation and behavior of the embodiments were described without specific reference to the specific software code, it being understood that a person of ordinary skill in the art would be able to design software and control hardware to implement the embodiments based on the description herein.

The foregoing description of preferred embodiments of the present invention provides illustration and description, but is not intended to be exhaustive or to limit the invention to the precise form disclosed. Modifications and variations are possible in light of the above teachings or may be acquired from practice of the invention. Moreover, while a series of acts have been presented with respect to FIGS. 5, 7, and 8, the order of the acts may be different in other implementations consistent with the present invention. Moreover, non-dependent acts may be performed in parallel.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed:

1. A device for submitting potential passwords to a long-term memory component, and resetting it as necessary, comprising:
an interface for connecting the device to the long-term memory component;
a control circuit configured to submit potential passwords to a long-term memory component through the interface and to reset it as necessary; and
a user controllable switch that, when actuated by a user, causes the control circuit to commence a password attack.

2. The device of claim 1, wherein the control circuit is a circuit dedicated to submitting potential passwords to the long-term memory component and resetting it as necessary.

3. The device of claim 1, further comprising:
a casing configured to contain the control circuit and the interface, the user controllable switch being mounted on the casing, the casing being of a size that is portable by the user.

4. The device of claim 3, wherein the casing is a rectangular casing that is 5″×7″×1.3″ or smaller.

5. The device of claim 3, further comprising:
LED lights mounted on the casing and providing feedback relating to an operational status of the device to the user.

6. The device of claim 3, further comprising:
a cable emanating from the casing and connected to the interface, the cable being configured to connect to the long-term memory component.

7. The device of claim 3, wherein the cable is an Integrated Device Electronics (IDE) cable.

8. The device of claim 3, further comprising:
an anti-static pad positioned on an external side of the casing and configured to support the long-term memory component during a password identification attack of the long-term memory component.

9. The device of claim 1, further comprising:
a power supply configured to supply power to the control circuit.

10. The device of claim 9, further comprising:
a drive power cord emanating from the casing and configured to supply power from the power supply to the long-term memory component.

11. The device of claim 1, wherein the switch, when actuated by the user, causes the control circuit to commence a password attack on the long-term memory component.

12. The device of claim 1, wherein the method of choosing potential passwords is configurable.

13. The device of claim 1, wherein the device contains a long term memory device to store potential passwords and algorithms.

14. The device of claim 3, further comprising:
an interface mounted on the casing which a user may attach a display device for viewing device status and results of password attack.

15. A method of password attack by an attacking device of a long-term memory component installed in a computer, the method comprising:
connecting a cable associated with the attacking device to the long-term memory component in the computer;
powering-up the computer;
activating the attacking device via a switch attached to the attacking device;
password attacking the long-term memory component; and
signaling completion of the attack of the long-term memory component.

16. The method of claim 15, wherein the long-term memory component is a disk drive.

17. The method of claim 15, wherein signaling completion of the attack is performed via one or more light emitting diodes (LEDs).

18. The method of claim 15, wherein the specific method of choosing potential passwords is configurable.

19. The method of claim 15, wherein the results of the password attack are viewable by a user.

20. A method of password attack by an attacking device of a long-term memory component installed in a computer, the method comprising:
connecting a cable associated with the attacking device to the long-term memory component;
connecting a power cable attached to the attacking device to the long-term memory component;
activating the attacking device;
password attacking the long-term memory component; and
signaling completion of the attack of the long-term memory component.

21. The method of claim 20, wherein the long-term memory component is a disk drive.

22. The method of claim 20, wherein signaling completion of the password attack includes illuminating one or more light emitting diodes (LEDs).

23. The method of claim 20, wherein the specific capabilities of a long-term memory component's capabilities shown to a user is configurable.

24. The method of claim 20, wherein the results of the password attack are viewable by a user.

25. A device for password attacking a long-term memory component, comprising:
means for providing feedback relating to an operational status of the device to a user;
a user settable switch;
an interface for connecting to the long-term memory component; and
circuitry coupled to the means for providing feedback, the user settable switch, and the interface, the circuitry configured, when the switch is actuated by a user, to communicate with the long-term memory component through the interface and perform a password attack therefrom,
wherein the circuitry is enclosed in a portable casing, and the user settable switch and the interface are mounted on an external portion of the casing.

26. The device of claim 25, further comprising:
an anti-static pad positioned on an external portion of the casing and configured to support the long-term memory component during a password attack on the long-term memory component.

27. The device of claim 25, further comprising:
a power supply configured to supply power to the circuitry; and
a drive power cord emanating from the casing, the drive power cord receiving power from the power supply.

28. The device of claim 25, wherein the casing is a rectangular casing that is 5″×7″×1.3″ or smaller.

29. The device of claim 25, wherein the interface is an Integrated Device Electronics (IDE) interface.

30. The device of claim 25, wherein the circuitry includes an embedded microprocessor.

31. The device of claim 25, wherein the circuitry submits potential passwords to a long-term memory device and resets it as required.

32. The device of claim 25, wherein the circuitry includes a user display interface.

33. A system comprising:
means for interfacing with a hard disk drive;
means for providing power to the hard disk drive; and
switching means for initiating a password attack on the hard disk drive.

34. The system of claim 33, wherein the system is operating system independent relative to the hard drive.

34. The system of claim 33, wherein the hard disk drive is an Integrated Drive Electronics (IDE) disk drive.

35. The system of claim 33, wherein there are means for displaying the device status and results of a password attack.

36. The device of claim 1, further comprising; a standard PC communication port.

37. The device of claim 36, where the standard PC communication port is configured to cause the control circuit to commence a password attack.

38. The device of claim 1, further comprising non-volatile memory to store the results of a password attack.
